(19) United States
(12) Patent Application Publication
(10) Pub. No.: US 2002/0130289 A1
(43) Pub. Date: Sep. 19, 2002

(54) Low discharge slurry valve seal

(76) Inventors: Bruce P. Knobbe, Greenwood Springs, MS (US); Timothy C. Sumrall, Greenwood Springs, MS (US); Shaine G. Reeves, Amory, MS (US)

Correspondence Address: Menotti J. Lombardi, ITT Fluid Technology, 10 Mountainview Road - North, Upper Saddle River, NJ, 07458, US

(21) Appl. No.: 09/809,582

(22) Filed: Mar. 15, 2001

(51) Int. Cl. F16K 3/16

(52) U.S. Cl. 251/172

(57) ABSTRACT

A gate valve seal for a gate valve including a body having an inlet aperture and an outlet aperture, and a gate closure reciprocally disposed within the body between a closed valve position where the gate closure blocks the apertures and an open valve position where the gate closure does not block the apertures. The seal includes a first resilient seat for placement in the inlet aperture of the gate valve body and a second resilient seat for placement in the outlet aperture of the gate valve body. The seats sealingly engage one another and the gate closure when the closure cycles between the valve positions. Each of the seats includes an inner diametrical surface which generates sealing pressure that increases as internal pipeline pressure increases.

### FIELD OF THE INVENTION

This invention relates to slurry valves, and in particular, to a knife-gate valve designed especially for handling abrasive, high-density slurries, the valve having a seal configuration that utilizes the fluid pressure in the pipeline to energize resilient seats contained therein.

### BACKGROUND OF THE INVENTION

Valves designed especially for abrasive, high-density slurry service must be resistant to the abrasive wear of the slurry and have a minimum number of cavities, which can collect solids and cause jamming of the closure member. Single seated knife-gate valves have been used for slurry service for many years but are subject to wear and jamming unless equipped with special seats and flushing systems.

Dual, rubber seated knife-gate valves have evolved as an effective, alternative means for minimizing wear and jamming effects. The basic structure of such a valve is described in U.S. Pat. No. 5,464,035. The dual, rubber seats provide a wear resistant valve body liner, tight shutoff, and a minimal number of cavities for solids buildup. In this design, the gate closure is retracted from the slurry flow stream when the valve is open, resulting in no wear on the gate when the valve is open. To close the valve, the gate closure is pushed between the rubber seats, separating and compressing the rubber, until the gate closure extends through the portway and stops the flow of the slurry. The gate closure is retracted when the valve is to be opened.

Although dual, rubber seated knife-gate valves have good wear characteristics and resistance to jamming, the inherent leakage rates during the valve's opening and closing cycle are a problem in many applications. More specifically, the shape of the leading edge of the gate closure, the configuration of the seats, and the properties of the material used for the seats (typically rubber) effect how much fluid leaks when the gate closure pushes through and separates the seats as the gate closure closes the valve, when the gate closure pulls away from between the seats as the gate closure opens the valve, and when the gate closure fully withdraws from between the seats as the gate closure fully opens the valve. Current designs rely, in a large measure, on the memory and recovery rate properties of the seat rubber to cause the seat to decompress and reseat and seal against the gate closure as the gate closure is retracted. Unfortunately, reseating is typically delayed thereby resulting in leakage.

Therefore, an improved knife-gate valve seal configuration which reduces leakage during cycling is needed.

### SUMMARY OF THE INVENTION

A gate valve seal for a gate valve including a body having an inlet aperture and an outlet aperture, and a gate closure reciprocally disposed within the body between a closed valve position where the gate closure blocks the apertures and an open valve position where the gate closure does not block the apertures. The seal comprises a first resilient seat for placement in the inlet aperture of the gate valve body and a second resilient seat for placement in the outlet aperture of the gate valve body. The seats sealingly engage one another and the gate closure when the closure cycles between the valve positions. Each of the seats includes an inner diametrical surface which generates sealing pressure that increases as internal pipeline pressure increases.

In another aspect of the present invention, a gate valve assembly comprises a body having an inlet aperture and an outlet aperture; resilient seats disposed in the apertures; and a gate closure reciprocally disposed within the body between a closed valve position where the gate closure blocks the apertures and an open valve position where the gate closure does not block the apertures. The seats sealingly engage one another and the gate closure when the closure cycles between the valve positions. Each of the seats includes an inner diametrical surface which generates sealing pressure that increases as internal pipeline pressure increases.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is a perspective view of a gate valve assembly according to an exemplary embodiment of the present invention;

FIG. 2 is a perspective view of an exemplary embodiment of a seat made according to the principles of the present invention;

FIG. 3 is a cross-sectional view through the seat of the present invention in an uncompressed state;

FIG. 4A is a perspective cross-sectional view through the gate valve assembly of FIG. 1 showing the gate closure fully retracted from between the seats in the fully opened valve position;

FIG. 4B is a perspective cross-sectional view through the gate valve assembly of FIG. 1 showing the gate closure in midstroke of an opening or closing cycle;

FIG. 4C is an enlarged perspective cross-sectional view through the gate valve assembly of FIG. 4B showing the relationship between gate closure and the seats; and

FIG. 4D is a perspective cross-sectional view through the gate valve assembly of FIG. 1 showing the gate closure between the seats and completely separating them in the fully closed valve position.

### DETAILED DESCRIPTION OF THE INVENTION

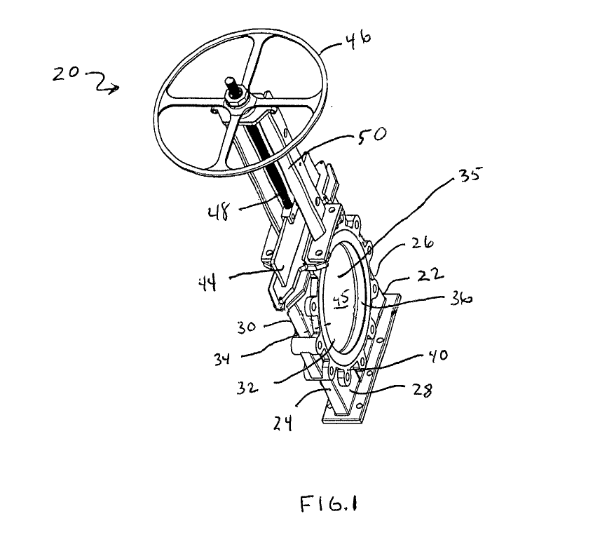

Referring to FIG. 1, there is shown an exemplary knife-gate valve assembly made according to the principles of the present invention. The valve assembly 20 includes an open bottom or closed bottom body 22 (open bottom body is depicted in FIG. 1) having a front wall 24, a rear wall 26, a first side wall 28, and a second side wall 30. The walls 24, 26, 28, 30 cooperate to define therewithin a chamber (not visible). The first side wall 28 has a first aperture 32 formed therein and the second side wall 30 has a second aperture 34 formed therein, the apertures 32, 34 defining a portway 35. A gate valve seal formed by a pair of annular, resilient seats 36 are disposed in the first and second apertures 32, 34. The seats 36 may be composed of any material having adequate strength and resilience, such as rubber or plastic. Pipeline bolting flanges 40 (only one of which is shown) rim the first and second apertures 32, 34.

A sliding gate closure 44 is reciprocably disposed in the chamber for opening and closing the portway 35 defined by the apertures 32, 34. An operator 46, such as a handwheel, effects translation of the gate closure 44 via a threaded rod 48 and yoke 50. The gate closure 44 may also be translated via a fluid actuator and linkage arrangement (not shown).

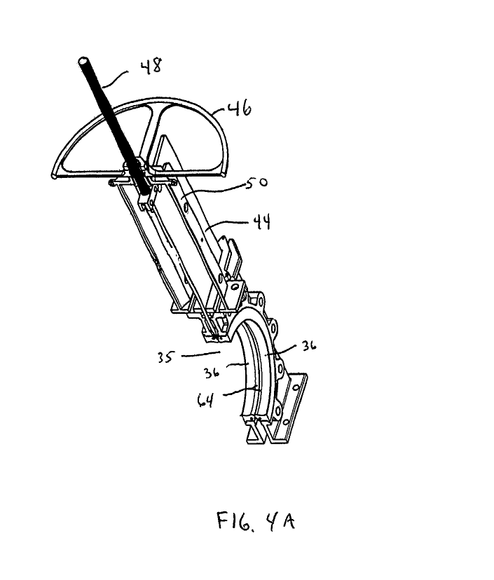

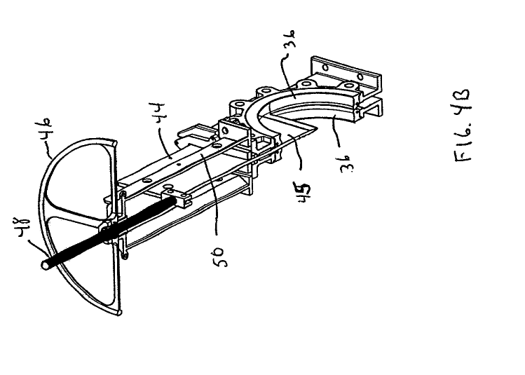

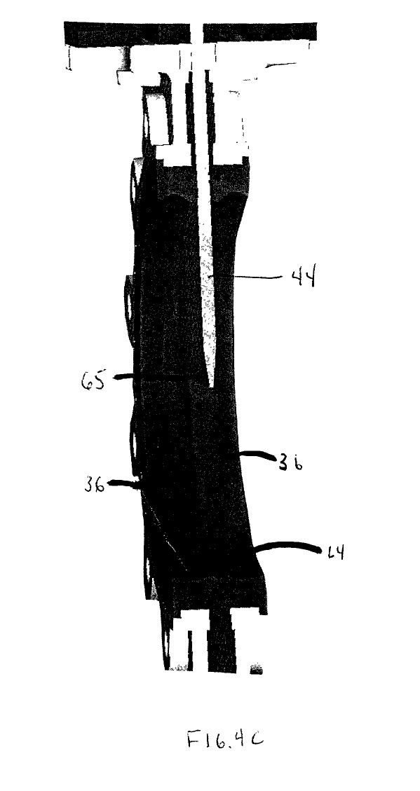

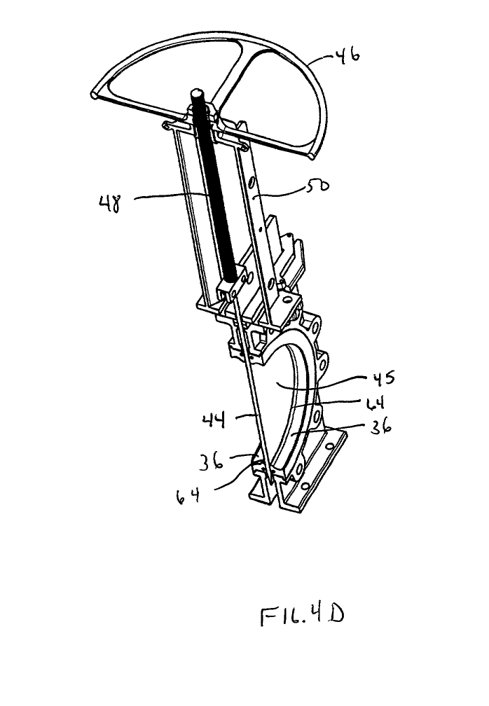

In operation, the valve assembly 20 is typically bolted between two pipeline mating flanges (not shown). The resilient seats 36 are held in the body 22 and the apertures 32, 34 by the mating flanges, and are compressed against the gate closure 44 and mating flanges to effect a seal at both locations. When the valve assembly 20 is fully opened such that the portway 35 is no longer occluded and the gate closure 44 is fully withdrawn from between the seats 36 (FIG. 4A), the flanges compress the seats 36 against one another thereby providing a seal against internal pipeline pressure. One of ordinary skill in the art should recognize that when the valve is in the “fully opened” position the gate closure 44 may not be fully withdrawn from between seats 36. In particular, the leading edge of the gate closure 44 may remain between the upper portions of the seats 36 but not within the portway 35 in the fully opened valve position.

To close the valve assembly 20, the handwheel operator 46 pushes the gate closure 44 into and through the seats 36, separating the seats 36 but effecting a seal against the gate closure surface 45. To open the valve, the handwheel operator 46 pulls the closure gate 44 back through the seats 36 until it is retracted from the portway 35.

The gate valve seal configuration formed by the resilient seats 36 of the present invention achieves a reduction in leakage during cycling because the seats 36 are configured to be energized by fluid pressure in an associated pipeline, thereby overcoming the memory and recovery problems inherent in the resilient material used for the seats 36. More specifically, the seats 36 are configured so that internal pipeline pressure pushes them against the gate 44, thereby overcoming any memory loss inherent in the composition of the seats 36 caused by the seats 36 being compressed and strained.

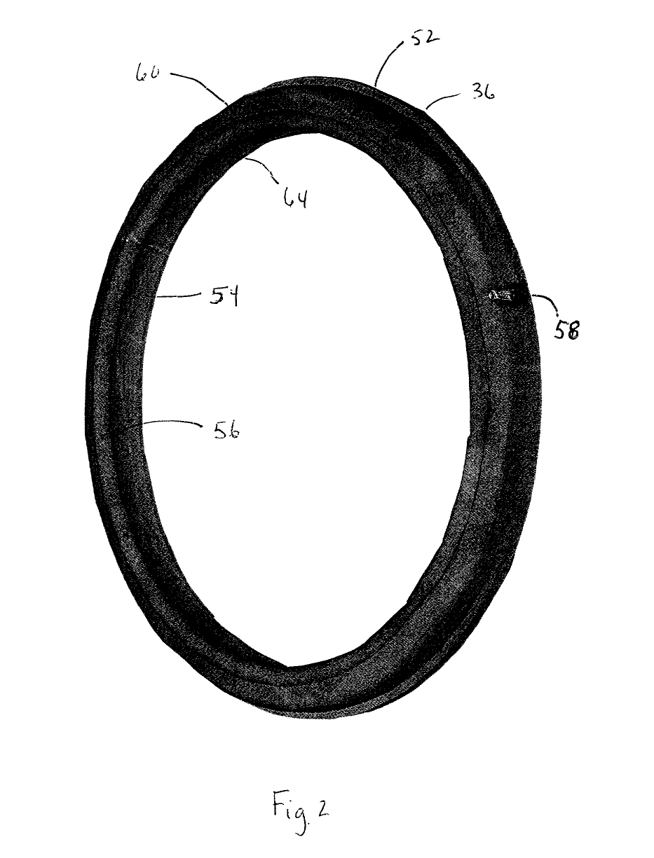

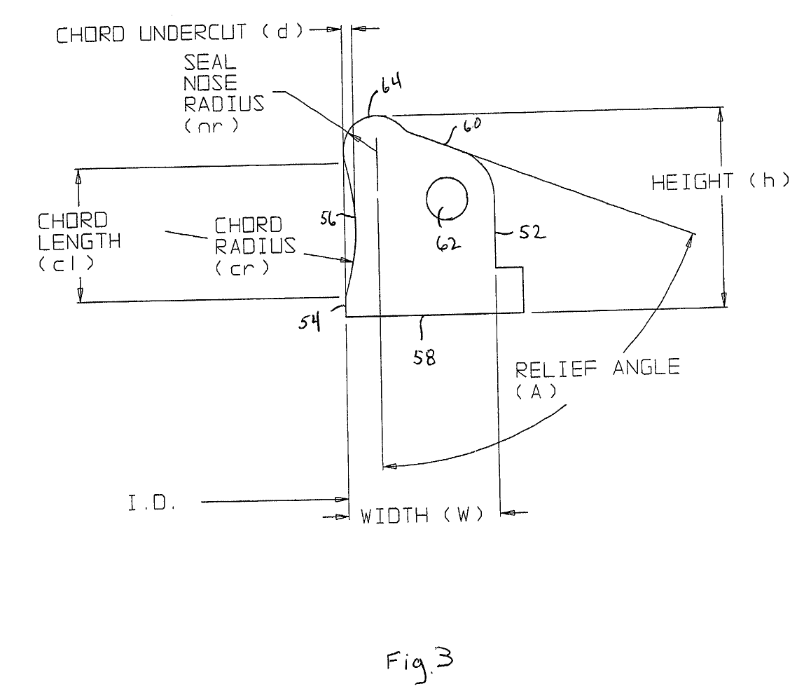

FIGS. 2 and 3 show in detail an exemplary embodiment of one of the annular resilient seats 36 made according to the principles of the present invention. The seat 36 includes an outer diametrical aperture seating surface 52, an inner diametrical surface 54 with a concave segment or chord 56 disposed opposite the aperture seating surface 52, a flange engagement surface 58, and an inclined gate engagement surface 60 disposed opposite the flange engagement surface 58. A seal nose 64 is defined at the junction of the inclined gate engagement surface 60 and the concave segment or chord 56 (or inner diametrical surface 54). The seal nose 64 extends beyond the inclined gate engagement surface 60. The seat 36 is reinforced by a stiffener ring 62 molded therein in the upper and outer quadrant of the seat 36. The stiffener ring 62 may be made of metal or plastic and configured to prevent collapse of the seat 36 due to gate closure forces, or extrusion of the seat due to pipeline pressure.

As shown in FIG. 3, the seat 36 has a height h, a width w, a chord radius cr, a chord length cl, a chord undercut d, a seal nose radius nr, and a relief angle a. These dimensions are interrelated to effect an optimized seal. For example, in a preferred embodiment, the length of the chord cl may be 72% +/−15% of the height h. The depth of the chord undercut d may be 0.115 inches +/−0.030. The radius of the chord cr may be 100% +/−50% of the height h. The seal nose radius nr may be 20% +/−5% of the seal width w. The relief angle a may be 65 degrees +/−15 degrees.

FIG. 4A shows the seats 36 with gate 44 fully retracted from between the seats 36 such that the valve is fully opened. As can be seen, the opposing seal nose sealing surfaces 64 of the seats 36 sealingly contact each other. FIGS. 4B and 4C show the seats 36 when the gate 44 is in the midstroke of the opening or closing cycle. In the midstroke position, the opposing seal nose sealing surfaces 64 of the seats 36 not separated by the gate closure 44 remain in sealing contact with each other, and in the transition area 65 (where the leading edge of the gate closure 44 separates the seats 36 as seen in FIG. 4C), the seal nose sealing surfaces 64 of the seats 36 sealingly contact the gate closure 44. Note that the transition area 65 at the leading edge of the gate 44 is the area where more leakage typically occurs when conventional seats are employed. FIG. 4D shows the seats 36 when the gate closure 44 is closed and the opposing seal nose sealing surfaces 64 are compressed and in contact with the gate closure 44.

The shape of the concave segment or chord 56 of the seat 36 allows internal pipeline pressure to push the seal nose sealing surfaces 64 of the seats 36 against each other in the open position, and against the gate closure 44 in the transition and closed position, providing a tighter and faster responding seal. The concave segment or chord 56 of the seat 36 also reduces the stress and strain, extending the seat life, by allowing the seat 36 to bend rather than being put under the direct compression initiated by the gate cycling to the closed position or internal pipeline pressure pushing the gate closure 44 into the seat 36. The resulting hydrostatic force acting on the resilient seal nose sealing surface 64 overcomes the relatively slow rate of recovery of the material, which occurs as the gate closure 44 is retracted and the compressed resilient seat 36 is relaxed and must quickly seal against the mating seat 36 to prevent external leakage. There is also another beneficial effect in that there is an increase in sealing pressure as pipeline pressure increases, making it a pressure compensating seal.

The valve assembly 20 of the present invention is applicable to any fluids piping system that will allow some external leakage when the valve is cycled open or closed, but requires tight shutoff in the closed position, and an unobstructed portway in the open position. The valve assembly 20 is also useful in applications that contain fluid slurries and where a valve configuration is required that has a minimal number of internal pockets for solids to settle or collect.

Typical applications may include mining and power industries. In particular, the valve assembly 20 of the present invention is suitable for those mining and power industry applications that have high slurry densities or slurry properties resulting in problems with other valve configurations.

While the foregoing invention has been described with reference to the above embodiments, various modifications and changes can be made without departing from the spirit of the invention. Accordingly, all such modifications and changes are considered to be within the scope of the appended claims.

What is claimed is:

1. A gate valve assembly comprising:
a body having an inlet aperture and an outlet aperture;
resilient seats disposed in the apertures;
a gate closure reciprocally disposed within the body between a closed valve position where the gate closure blocks the apertures and an open valve position where the gate closure does not block the apertures;
the seats sealingly engaging one another and the gate closure when the closure cycles between the valve positions;
each of the seats including an inner diametrical surface which generates sealing pressure that increases as internal pipeline pressure increases.

2. The gate valve assembly according to claim 1, wherein each of the seats includes a laterally protruding sealing surface.

3. The gate valve assembly according to claim 2, wherein the laterally protruding sealing surfaces of the seats engage one another when the gate closure is in the open valve position and engage the gate closure when the gate closure is in the closed valve position.

4. The gate valve assembly according to claim 3, wherein the laterally protruding sealing surfaces maintain their engagement with one another and the gate closure as the gate closure is cycled between the valve positions.

5. The gate valve assembly according to claim 1, wherein the resilient seats are composed of rubber.

6. The gate valve assembly according to claim 1, wherein the resilient seats are composed of plastic.

7. The gate valve assembly according to claim 1, wherein the resilient seats are annular.

8. The gate valve assembly according to claim 1, wherein the resilient seats include a stiffener ring.

9. The gate valve assembly according to claim 1, further comprising an operator for effecting translation of the gate closure.

10. The gate valve assembly according to claim 1, further comprising an actuator for effecting translation of the gate closure.

11. A gate valve seal for a gate valve including a body having an inlet aperture and an outlet aperture, and a gate closure reciprocally disposed within the body between a closed valve position where the gate closure blocks the apertures and an open valve position where the gate closure does not block the apertures, the seal comprising;
a first resilient seat for placement in the inlet aperture of the gate valve body; and
a second resilient seat for placement in the outlet aperture of the gate valve body;
the seats sealingly engaging one another and the gate closure when the closure cycles between the valve positions;
each of the seats including an inner diametrical surface which generates sealing pressure that increases as internal pipeline pressure increases.

12. The gate valve seal according to claim 11, wherein each of the seats includes a laterally protruding sealing surface.

13. The gate valve seal according to claim 12, wherein the laterally protruding sealing surfaces of the seats engage one another when the gate closure is in the open valve position and engage the gate closure when the gate closure is in the closed valve position.

14. The gate valve seal according to claim 13, wherein the laterally protruding sealing surfaces maintain their engagement with one another and the gate closure as the gate closure is cycled between the valve positions.

15. The gate valve seal according to claim 11, wherein the resilient seats are composed of rubber.

16. The gate valve seal according to claim 11, wherein the resilient seats are composed of plastic.

17. The gate valve seal according to claim 11, wherein the resilient seats are annular.

18. The gate valve seal according to claim 11, wherein the resilient seats include a stiffener ring.
